(19) United States
(12) Patent Application Publication
(10) Pub. No.: US 2018/0168139 A1
(43) Pub. Date: Jun. 21, 2018

(54) Furniture Protector Against Bed Bugs and Other Crawling Insects

(71) Applicant: University of Florida Research Foundation, Inc., Gainesville, FL (US)

(72) Inventors: Philip G. Koehler, Gainesville, FL (US); Roberto M. Pereira, Gainesville, FL (US); Benjamin A. Hottel, Tallahassee, FL (US)

(21) Appl. No.: 15/647,607

(22) Filed: Jul. 12, 2017

Related U.S. Application Data
(63) Continuation of application No. PCT/US16/16839, filed on Feb. 5, 2016.
(60) Provisional application No. 62/112,926, filed on Feb. 6, 2015.

(51) Int. Cl. A01M 1/10; A01M 1/02

(52) U.S. Cl. CPC A01M 1/103; A01M 1/00; A01M 1/10; A01M 1/02

(57) ABSTRACT

Pitfall traps, coasters, devices, apparatus, systems and methods for capturing crawling insects, such as bed bugs, and/or for preventing the insects from climbing up furniture legs to furniture such as beds, cots, chairs and any type of furniture where a person would rest or sleep. Smooth slick surfaces and/or pesticide treated surfaces can be located on underside facing horizontal or angled surfaces used with or without sticky surfaces which all can be used to prevent insect and bed bug travel and assist in helping trap the insects and bed bugs.

### CROSS REFERENCE TO RELATED APPLICATION

This application is a Continuation of Patent Cooperation Treaty Application PCT/US16/16839 filed Feb. 5, 2016, which claims the benefit of priority to U.S. Provisional Application Ser. No. 62/112,926 filed Feb. 6, 2015. The entire disclosure of each of the applications listed in this paragraph are incorporated herein by specific reference thereto.

### FIELD OF INVENTION

This invention relates to insect control devices, and in particular to pit fall traps, coasters, devices, apparatus, systems and methods having underside facing surfaces with smooth (slick) and/or pesticide treated surfaces for allowing the capturing of crawling insects, such as bed bugs, and for preventing insects and bed bugs from climbing up furniture legs to furniture such as beds.

### BACKGROUND AND PRIOR ART

Circular pitfall traps are the most common way to protect furniture from bed bugs that crawl from the room onto the bed and to monitor bed bug populations. These circular traps have pitfall areas with almost vertical sides that are either too smooth for a bed bug to climb or coated with talc so the bugs cannot get a grip to climb. There are several problems with these types of traps. Debris easily falls in the traps and coats the sides with dirt. Bed bugs then can easily climb out. Also, when placing traps with pitfall sides coated with talc, the talc is easily removed by touching with fingers or hands. Bed bugs can, over time, climb these smooth or talc-coated surfaces, so bed bug escape from these traps can occur.

Sticky traps have become popular for monitoring/trapping crawling insects, such as cockroaches and the like. However, traditional sticky traps have problems in trapping bed bugs. For example, research has shown that when a bed bug approaches a sticky trap, the bed bug touches one part of the sticky trap and is able to use their other legs which are not on the sticky trap enough leverage to pull the trapped leg(s) from the sticky traps.

The use of transparent paper such as acetate paper, surrounding a sticky trap can be smooth enough to reduce the leverage factor to prevent the bed bug from pulling themselves off the trap. However, test data has shown that using too smooth of a surface causes a behavior problem where the bed bug actually avoids traveling on the smooth. For example, U.S. Pat. No. 5,572,825 to Gehret describes a glue trap having a slippery surface about the perimeter that does not allow for the cockroach to have enough leverage to remove themselves from the sticky trap. The problem is that the “silicone coated . . . paper . . . ” referenced in this patent has been demonstrated to cause bed bugs to avoid the surface as a travel surface. The too slippery surface causes a behavior effect in the bed bugs to avoid contact with very slippery surfaces.

A major problem in motels and hotels is the proliferation of bed bug type insects that can travel from the floor up legs of furniture. The above devices are not capable of stopping and preventing all bed bugs from climbing from a floor location up legs to furniture, such as beds, and the like.

Thus, the need exists for solutions to the above problems with the prior art.

### SUMMARY OF THE INVENTION

A primary objective of the present invention is to provide traps, coasters, devices, apparatus, systems and methods for preventing and capturing insects, such as bed bugs, from climbing up furniture legs to furniture where persons rest or sleep thereon.

A secondary objective of the present invention is to provide traps, coasters, devices, apparatus, systems and methods for preventing and capturing insects that combines a smooth(slick) surface along with or without a sticky surface for protecting furniture from insects, such as bed bugs.

A third objective of the present invention is to provide traps, coasters, devices, apparatus, systems and methods for preventing and capturing insects that combines a pesticide treated surface along with or without a sticky surface for protecting furniture from insects, such as bed bugs

The invention can work with different types of furniture, such as but not limited to beds, cots, bassinets, cribs, easy chair, reclining chairs, and any other furniture, where a person would rest or sleep.

This invention encompasses a novel pitfall trap with an inner lip and an outer lip overhanging the pitfall area. The sides do not need to be smooth or talc-coated, but the underside of the lip can be smooth(slick) with or without pesticide treated to prevent bed bug/insect movement.

There are several reasons this invention is superior to vertical smooth sides. The first is that bed bugs have more difficulty crossing the underside smooth(slick) and/or pesticide treated surface upside down. The bugs cannot hang on the surface and fall into the pitfall part of the trap. Therefore, this invention is better for capturing bed bugs. A second reason the trap is superior is that the underside smooth/pesticide surface is protected from debris that falls from the room into the trap. Debris falls on the sides and bottom of the trap, but does not adhere to the inner smooth/pesticide underside surface. Therefore the trap remains effective when used as directed.

The bottom of the trap can be coated with insecticide to kill bugs that fall into the trap or with sticky glue to retain them. The coating is not necessary to retain the bugs but is an optional part of the trap.

This Invention incorporates one or more of the following elements in order to produce a barrier that prevents bed bugs and other crawling insects from climbing on a piece of furniture.

An embodiment of the invention can be the combination of both a sticky surface in the pit to prevent insect escape and a slick surface or a pesticide-treated surface on the underside of a barrier the insects have to cross.

The novel pitfall trap barrier can be used to prevent bed bugs and other crawling insects from climbing on a piece of furniture. The inside of the pitfall can optionally be lined with a sticky substance to prevent insect escape. The underside of the barrier is a slick or pesticide treated surface in order to further prevent escape.

The invention can combine slick(smooth) surfaces to be adjacent to sticky surfaces, where the insect becomes stuck on the sticky surface and cannot remove themselves because they cannot get traction leverage by stepping on the adjacent (i.e. direction next to one another) slick(smooth) surface.

Further objects and advantages of this invention will be apparent from the following detailed description of the presently preferred embodiments which are illustrated schematically in the accompanying drawings.

### BRIEF DESCRIPTION OF THE FIGURES

FIG. 1A is a top view of a first embodiment of a trap barrier.

FIG. 1B is a cross-sectional view of the trap barrier of FIG. 1A along arrows 1B FIG. 2A is a top view of a second embodiment trap barrier.

FIG. 2B is a cross-sectional view of the trap barrier of FIG. 2A along arrows 2B.

FIG. 3A is a top view of a third embodiment trap barrier.

FIG. 3B is a cross-sectional view of the trap barrier of FIG. 3A along arrows 3B.

FIG. 3C is a bottom view of the trap barrier of FIG. 3A.

FIG. 4A is a top view of a fourth embodiment trap barrier.

FIG. 4B is a cross-sectional view of the trap barrier of FIG. 4A along arrows 4B.

FIG. 4C is a bottom view of the trap barrier of FIG. 4A.

FIG. 5A is a top view of a fifth embodiment trap barrier.

FIG. 5B is a cross-sectional view of the trap barrier of FIG. 5A along arrows 5B.

FIG. 5C is a bottom view of the trap barrier of FIG. 5A.

FIG. 6 is a side cross-sectional view of the first embodiment trap barrier used with a small furniture leg.

FIG. 7 is a side cross-sectional view of the first embodiment trap barrier used with a large furniture leg.

FIG. 8 is a side cross-sectional view of the first embodiment trap barrier supporting the bottom of a furniture leg.

FIG. 9 is a table of bedbugs trapped in the top of the trap, within the trap and outside of the trap.

FIG. 10 is a graph of the percentage of bed bugs trapped in the top of the trap, within the trap and outside of the trap.

FIG. 11 shows a top view of the UF urban entomology trap used for testing.

FIG. 12 shows a top view of a commercial climb up trap used for testing.

FIG. 13 is a graph showing the percentage of bed bug traps failed after 7 days.

FIG. 14 is a graph showing the percentage of escaped adult KVS bed bugs after 7 days.

FIG. 15A is a top view of a sixth embodiment trap barrier.

FIG. 15B is a side cross-sectional view of the trap barrier of FIG. 15A along arrows 15B.

### DESCRIPTION OF THE PREFERRED EMBODIMENTS

Before explaining the disclosed embodiments of the present invention in detail it is to be understood that the invention is not limited in its applications to the details of the particular arrangements shown since the invention is capable of other embodiments. Also, the terminology used herein is for the purpose of description and not of limitation.

In the Summary above and in the Detailed Description of Preferred Embodiments and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, that feature can also be used, to the extent possible, in combination with and/or in the context of other particular aspects and embodiments of the invention, and in the invention generally.

In this section, some embodiments of the invention will be described more fully with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will convey the scope of the invention to those skilled in the art. Like numbers refer to like elements throughout, and prime notation is used to indicate similar elements in alternative embodiments.

A list of components will now be described.
100 Trap bottom
102 outer wall of well(moat)
104 angled outer wall of well(moat)
106 inner facing lip
107 Smooth or pesticide treated surface
110 Side wall
120 Furniture leg well
130 Large furniture leg support
140 Smooth or pesticide treated surface
150 Sticky surface
160 Slick surface to facilitate furniture move
200 Protector top
310 Side wall
220 Furniture leg bolt hole
240 Smooth or pesticide treated surface
300 Protector top
310 Side wall
320 Furniture attachment peg
340 Smooth or pesticide treated surface
350 Furniture support leg
360 Caster
400 Furniture protector
500 small furniture leg
550 Large furniture leg
600 Furniture bottom
700 Embodiment without well(moat)

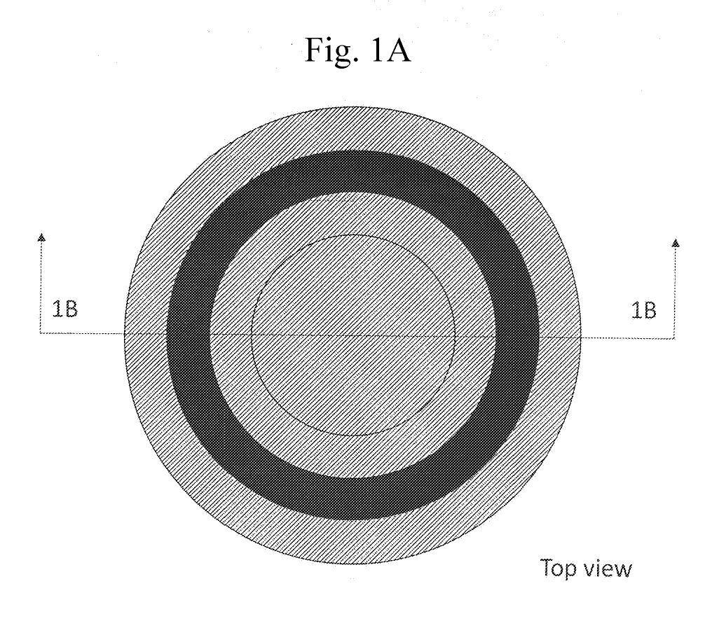

FIG. 1A is a top view of a first embodiment of a trap barrier. FIG. 1B is a cross-sectional view of the trap barrier of FIG. 1A along arrows 1B.

Referring to FIGS. 1A-1B, the trap barrier can include a solid base bottom 100 having a generally ring shaped pit or moat with a sticky surface 150 and an inner wall 110 for supporting a furniture leg inside of a well area 120 and having an outwardly bent edge 130 with a lower facing surface having a smooth surface or pesticide treated surface.

The barrier can have an outer wall 102 having an inwardly bent edge 106, with an undersurface 107 that can have a smooth(slick) or pesticide-treated surface. Additionally, the undersurface can be both a smooth(slick) surface with a pesticide treated surface.

The inner wall 110 can have a greater height than the outer wall 102. Underneath the base bottom 100 can be a surface 160 such as a slick surface to facilitate moving furniture that is supported by the barrier. Here, the outer wall 102 is generally perpendicular to the base 100.

Smooth surface 140, 107, can include but is not limited to any plastic material, such as but not limited to plastic laminated paper, polyurethane, polyacrylic, and Plexiglas.

Pesticide treated surfaces 140, 107 can include but are not limited to Pyrethroids (e.g. permethrin, cypermethrin, lambacyhalothrin, cyfluthrin), organophosphates (e.g. malathion, dichlorvos), carbamates (e.g. propoxur, methomyl), repellents (e.g. diethyl toluamide, piperazines), essential plant oils (e.g. lemongrass oil, thyme oil, citronella, geraniol).

Sticky surface 150, such as but not limited to sticky surface such as those used in a Victor roach glue trap and monitor (Woodstream Corporation, Lititz, Pa.).

Slick surface 160, can include but is not limited to plastic, glass, Teflon coated metal, polished metal, smooth painted or varnished surfaces.

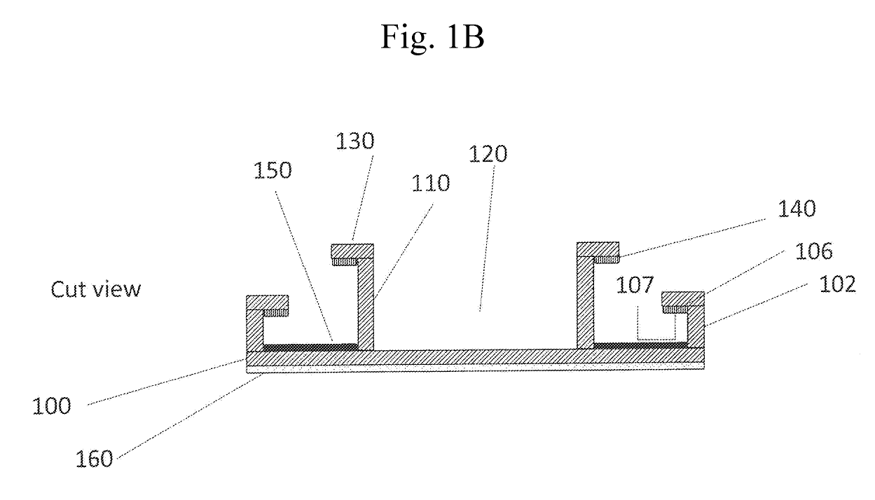

FIG. 2A is a top view of a second embodiment trap barrier. FIG. 2B is a cross-sectional view of the trap barrier of FIG. 2A along arrows 2B.

The embodiment in FIGS. 2A-2B is similar to that in the previous embodiment, with the exception of having the outer wall 104 angled inwardly from the base portion 100.

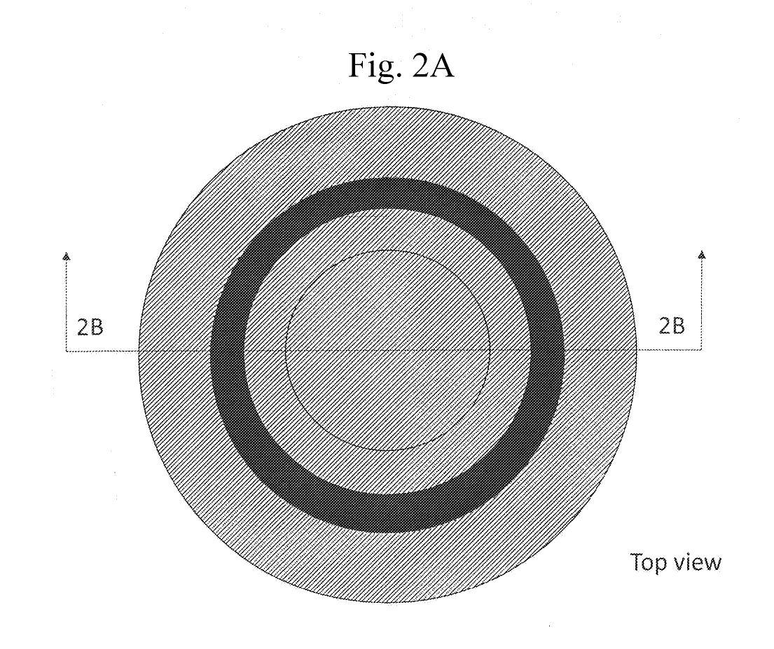

FIG. 3A is a top view of a third embodiment trap barrier. FIG. 3B is a cross-sectional view of the trap barrier of FIG. 3A along arrows 3B. FIG. 3C is a bottom view of the trap barrier of FIG. 3A.

A base portion 300 can form a protector top having a furniture attachment peg extending upward from a mid portion of the base for insertion into a bottom of a furniture leg. Extending below the base can be a downwardly protruding outer side wall 310 forming a channel therein with a furniture support leg 350 extending downwardly from a mid portion of the base. A channel can include a lower facing surface 340 having one of the smooth surface or the pesticide treated surface. The furniture support leg 350 is large enough to raise the outer side wall 310 above the floor support surface.

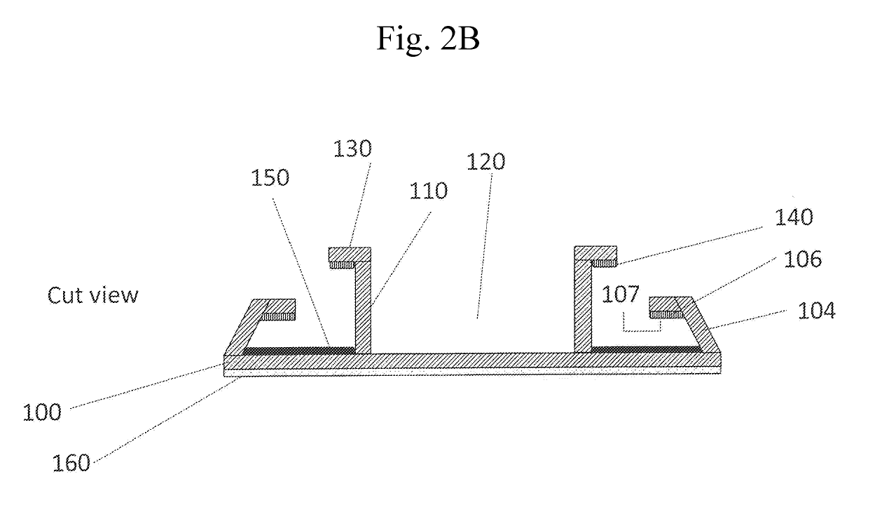

FIG. 4A is a top view of a fourth embodiment trap barrier. FIG. 4B is a cross-sectional view of the trap barrier of FIG. 4A along arrows 4B. FIG. 4C is a bottom view of the trap barrier of FIG. 4A.

FIGS. 4A-4C are similar to the embodiment of FIGS. 3A-3C with the exception of substituting a caster wheel 360 for the furniture support leg 350.

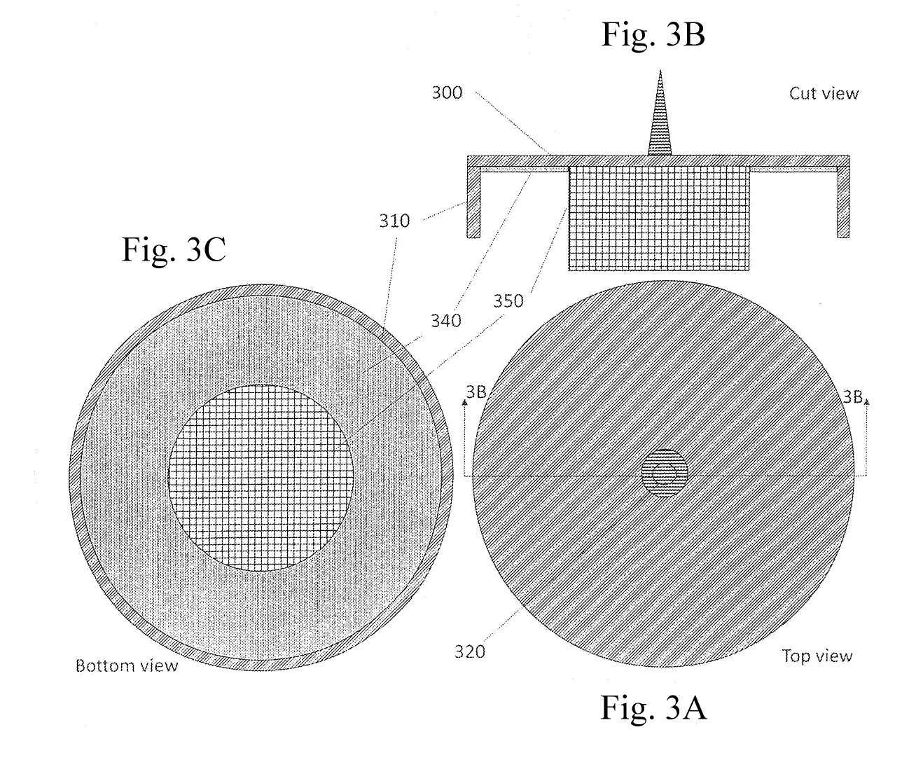

FIG. 5A is a top view of a fifth embodiment trap barrier. FIG. 5B is a cross-sectional view of the trap barrier of FIG. 5A along arrows 5B. FIG. 5C is a bottom view of the trap barrier of FIG. 5A.

FIGS. 5A-5C are similar to FIGS. 3A-4C with the exception of removing the peg and both the lower facing furniture leg or caster wheel, and instead having a through-hole 220 through the mid-portion of the base for allowing the barrier to be attached to a bottom of a furniture leg by a fastener, such as a screw of bolt.

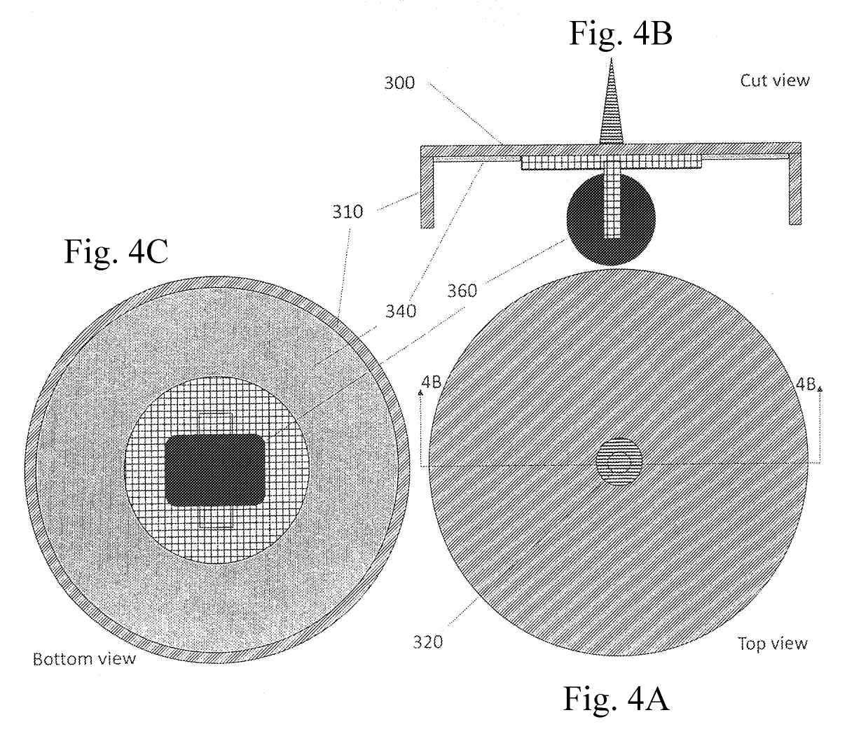

FIG. 6 is a side cross-sectional view of the first embodiment trap barrier 400 shown and described above in reference with FIGS. 1A-1B used with a small furniture leg 500 which supports a piece of furniture 600 in the wheel well of barrier.

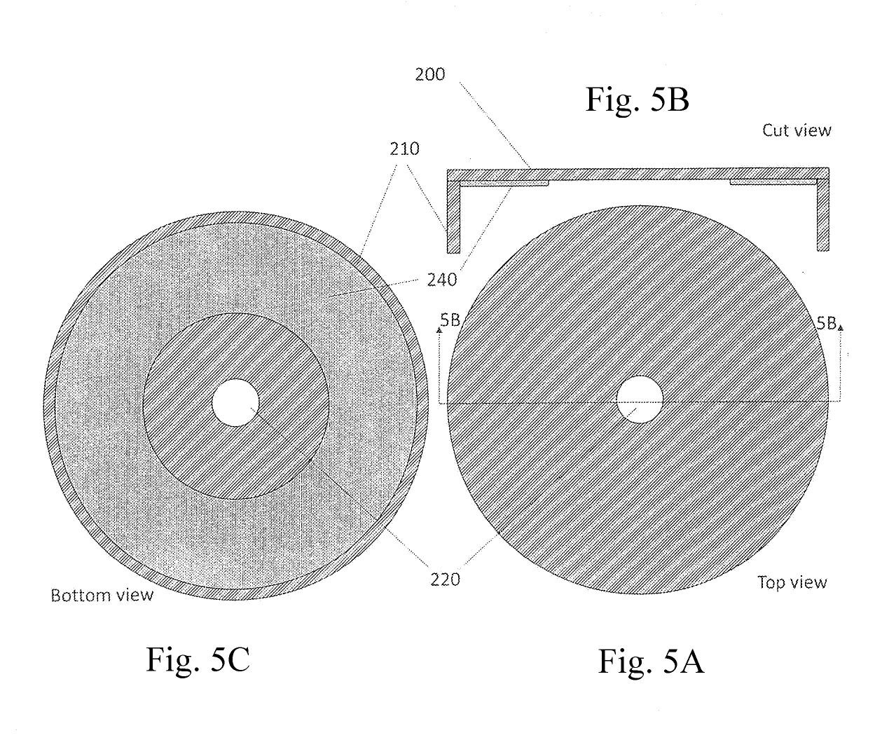

FIG. 7 is a side cross-sectional view of the first embodiment trap barrier 400 shown and described above in reference to FIGS. 1A-1B, used with a large furniture leg 500 underneath a piece of furniture 600 supported by the outwardly protruding upper edges of the inner wall.

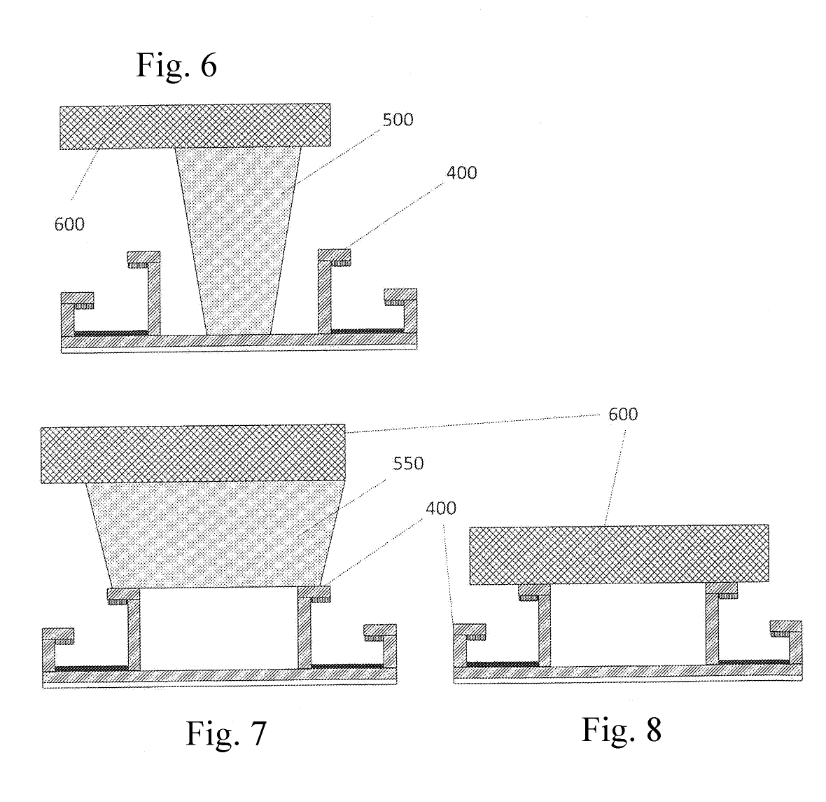

FIG. 8 is a side cross-sectional view of the first embodiment trap barrier 400 shown and described in FIGS. 1A-1B, with the piece of furniture 600

directly supporting the piece of furniture on the outwardly protruding edges of the inner wall.

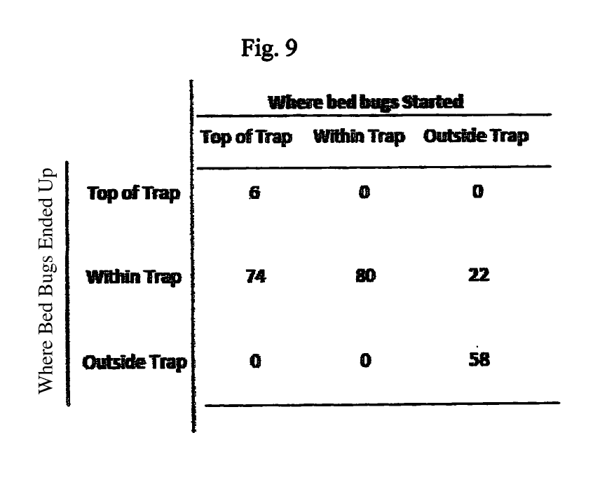

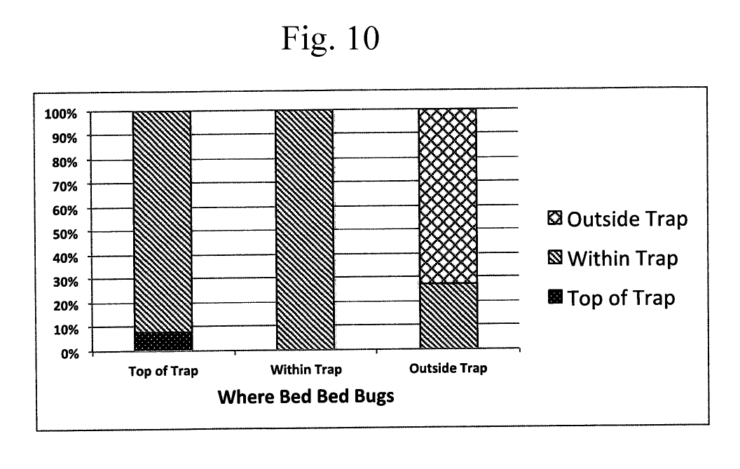

FIG. 9 is a table of bedbugs trapped in the top of the trap, within the trap and outside of the trap. FIG. 10 is a graph of the percentage of bed bugs trapped in the top of the trap, within the trap and outside of the trap.

Referring to FIGS. 9-10, the test data shows that bedbugs entering the top of the trap can only stay on the top or be trapped within the trap. Once bed bugs are within the trap they cannot escape either going to the top or to the outside of the trap. Bed bugs that are outside of the trap can only stay outside or be trapped within the trap.

The test data provides support for showing bed bugs on the ground cannot climb into the furniture being protected by the trap. Bed bugs already on the furniture can be trapped in the trap if they try to move away from the furniture.

Tests were done using a barrier trap according to the invention. 80 bed bugs were released either on top of the trap (where the furniture leg would be surrounded by the trap), within the trap (the pitfall part of the trap that captures bed bugs), and outside the trap (simulating bed bugs in the room from crawling onto the furniture). The only smooth surfaces of the trap were horizontal to the floor; all other traps have basically a vertical smooth or talc covered smooth surface. Bed bugs were left overnight.

During the test, no bed bugs in the pitfall part of the trap escaped. As such, the pitfall part of the trap has been shown to be 100% effective in preventing bed bugs from moving out of the pitfall area of the trap.

All bed bugs that left the top part of the trap were captured in the pitfall part of the trap. So it was 100% effective in capturing bed bugs that left the top of the trap (furniture contact area). Just a few remained on top of the trap at the end of the assay. A total of 92.5% of bed bugs were captured in this assay.

All bed bugs that moved from the perimeter area and crawled into the trap were captured. So the trap was 100% effective in protecting the legs of furniture from movement of bed bug released near the trap. There was no attractant on top of the trap and most bed bugs settled down in the area around the trap. So 27.5% of bed bugs were captured.

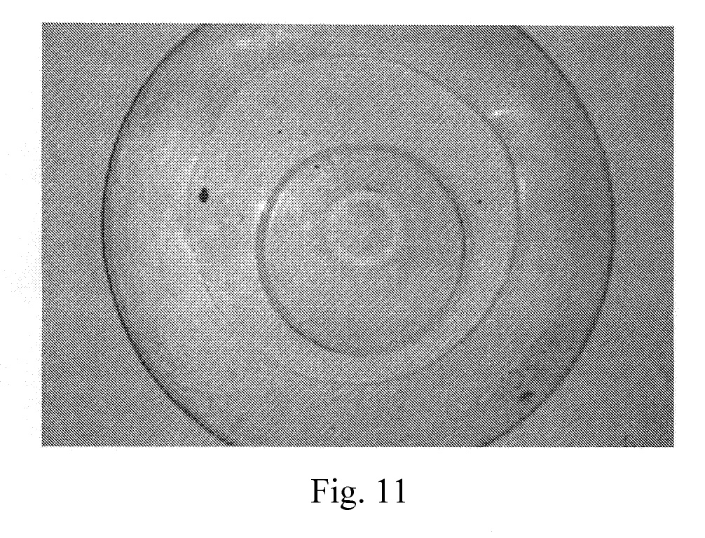

FIG. 11 shows a top view of the UF (University of Florida) urban entomology trap used for testing. The trap corresponds to FIGS. 1A and 1B described above.

The UF trap was prepared by adding 2 ml of Mountain Dew then drying the trap with a blow dryer on high heat for approximately 10 minutes. The excess fluid was then poured out and the trap remained unaltered for approximately 24 hours before introducing 8 bed bugs.

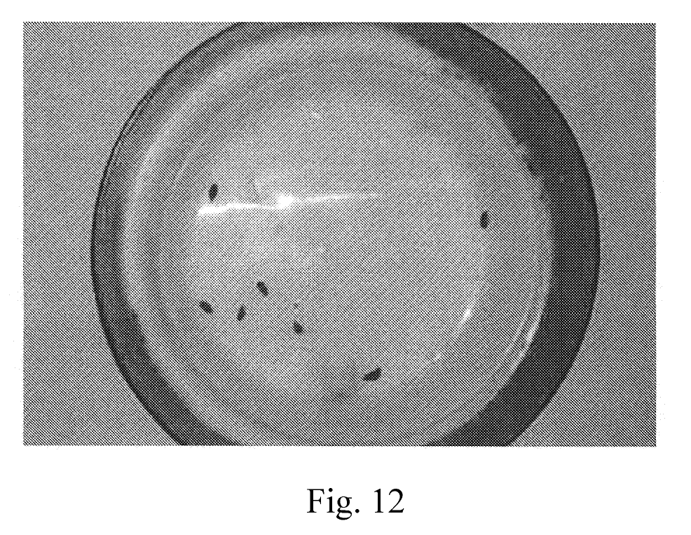

FIG. 12 shows a top view of a commercial climb up trap used for testing.

The Climb up Insect Interceptor is described and shown in U.S. Pat. No. 9,066,511 to McKnight et al. and includes plural pitfall traps to intercept crawling arthropods and insects.

The Climbup traps were prepared using 2 ml of Mountain Dew. The Mountain Dew was dried using the high heat and cool air settings on a blow dryer for approximately 10 minutes. The excess fluid was then poured out and the trap was untouched for approximately 24 hours before introducing 8 bed bugs.

Testing of 7 Climbup Intereceptors and 7 University of Florida Urban Entomology prototypes was done at the University of Florida, Urban Entomology Lab from spring to summer 2015.

In addition to the traps referenced above, the following materials were used with the traps during the experiments.
Roughly 1 tbsp Guacamole
A small hand full of Lays Original Potato Chips
˜2 tbsp Kraft Mac-n-Cheese singles cup, prepared following package instructions
Contents of a vacuum post use on a carpet in a house with animals (dogs and cats) where the owner uses carpet cleaner and pet odor eliminators
2 ml Original Hidden Valley Ranch salad dressing
˜120 adult Bed Bugs, KVS strain

During testing, food materials such as Guacamole, Potato Chips, Mac-n-Cheese, and salad dressing were dropped into both types of traps (the invention traps and the commercial traps) to simulate what could normally occur during normal use of the traps during human habitation conditions.

The open commercial climb up trap (FIG. 12) can become compromised where the food materials provide a walking surface for the travelling bed bugs to escape the trap and/or climb the furniture.

The dropped food materials on the UF trap (FIG. 11) does not compromise the purpose of the trap, because the slick and/or pesticide treated undersurfaces are not affected by the dropped food materials. As such normal habitation will not detrimentally affect the novel UF traps shown in FIG. 11 and other Figures in the subject application.

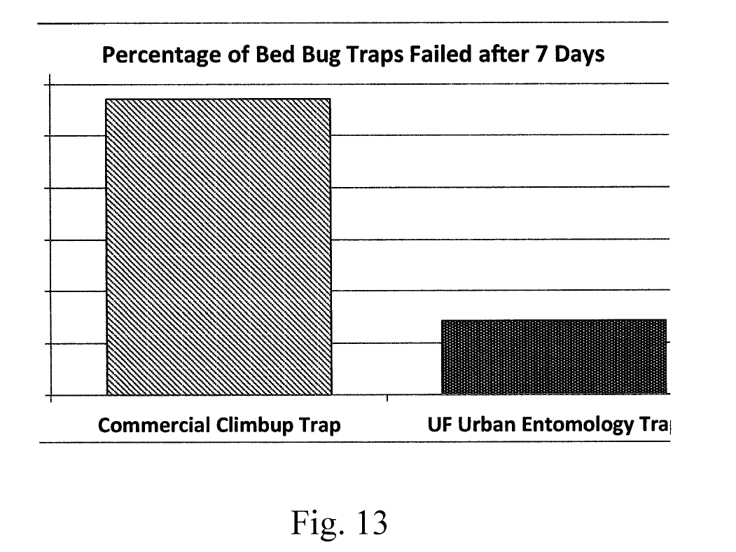

FIG. 13 is a graph showing the percentage of bed bug traps failed after 7 days. After 7 days of use, the UF traps had an approximately 13 to 14% failure rate. The commercial traps had an over 55% failure rate after 7 days which is approximately 4 times (400 percent greater) failure rate than the UF traps.

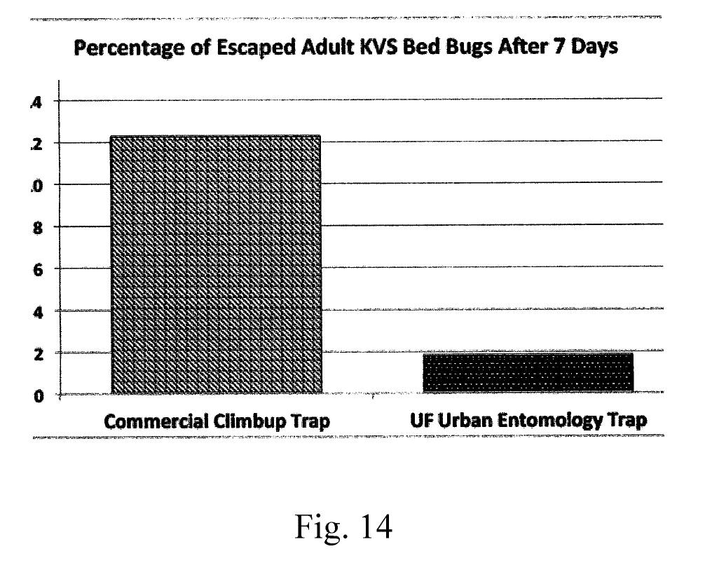

FIG. 14 is a graph showing the percentage of escaped adult KVS bed bugs after 7 days. The UF traps had a low percentage of less than approximately 2% of the bed bugs escaping from those traps. The commercial traps had a significantly greater than approximately 12% of the trapped bed bugs escaping from the traps, which is approximately 6 times (600 percent greater) than the UF trap escape percentages.

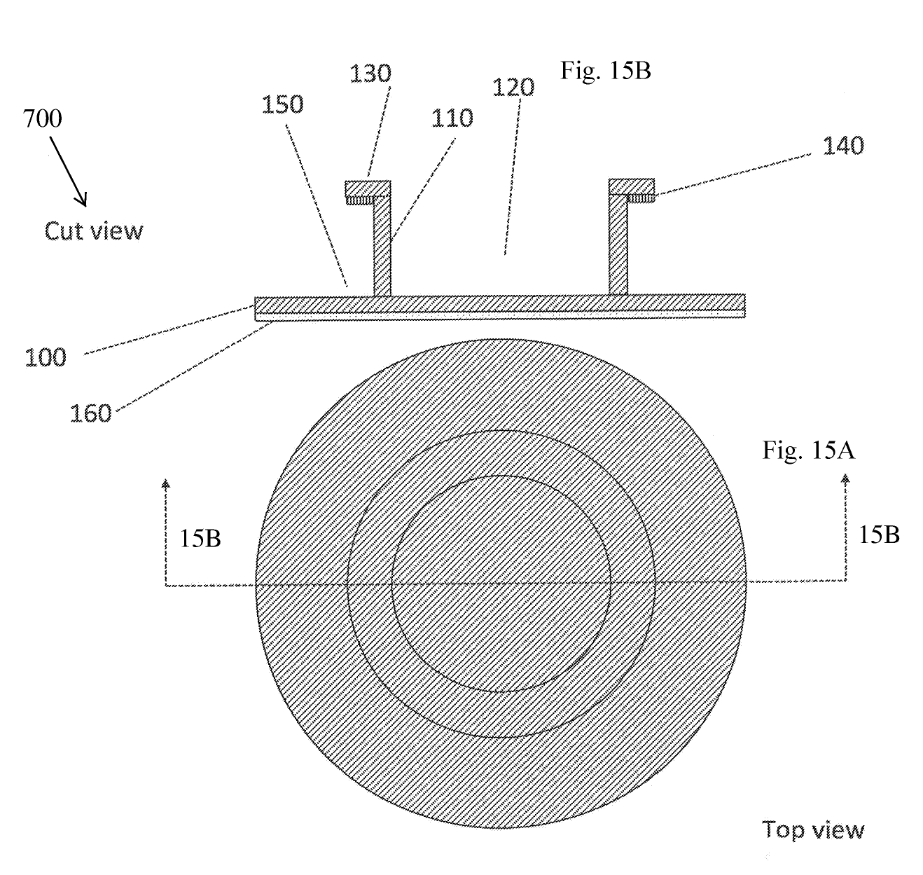

FIG. 15A is a top view of a sixth embodiment trap barrier 700. FIG. 15B is a side cross-sectional view of the trap barrier 700 of FIG. 15A along arrows 15B. The trap barrier 700 is similar to the trap barrier shown and described in reference to FIGS. 1A-1B, the outer well 102 and inner edge 106 are removed so that no trap well (moat) exists. As such crawling arthropods and bed bugs can reach the underside surface 140, which can be a smooth or pesticide treated surface which prevents the crawling arthropods and bed bugs from reaching furniture legs supported by the trap barrier 700.

With the embodiments described, above, the upside down smooth or pesticide treated surfaces would not generally attract dirt, since these treated surfaces are elevated underneath pitfall barriers.

Although the embodiments describe having either a smooth or pesticide treated under surface areas, the invention can be practiced with an underside surface area portions having a combined smooth(slick) and pesticide surface for the upside down facing surfaces that do not touch a floor surface.

The invention can be used in other applications in addition to being underneath furniture. For example, the novel traps can be placed in various locations around a space, such as on a floor, stairs, a shelf, top of furniture, in commercial locations (hotels, motels and the like) as well as any residential locations (houses, condominiums, and the like). The novel invention can be used in other areas were bed bugs can occur, such as but not limited to recreational vehicles, truck cabins, inside vans and automobiles, and the like.

While the invention has been described, disclosed, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

We claim:

1. A trap barrier for insects, comprising:
a base having an upper surface and a lower surface;
a single cylindrical inner wall and a single cylindrical outer wall forming a concentric channel with a floor surface therebetween on the upper surface of the base; and
a sticky surface on the floor surface of the concentric channel, and at least one of a smooth slick surface or pesticide treated surface on the barrier for both preventing insects from traveling and capturing insects thereon, wherein furniture supported by the base is protected from insects.

2. The trap barrier of claim 1, wherein the single cylindrical inner wall is higher than the single cylindrical outer wall.

3. The trap barrier of claim 2, wherein the single cylindrical inner wall includes an outwardly protruding upper bent edge, and the outer wall includes an inwardly protruding upper bent edge.

4. The trap barrier of claim 3, wherein the single cylindrical outer wall is substantially perpendicular to the base.

5. The trap barrier of claim 3, wherein the single cylindrical outer wall is sloped at an inward angle relative to the base.

6. The trap barrier of claim 3, wherein both the inwardly protruding upper bent edge and the outwardly protruding upper bent edge includes the smooth slick surface.

7. The trap barrier of claim 3, wherein both the outwardly protruding upper bent edge and the inwardly protruding upper bent edge includes the pesticide treated surface.

8. The trap barrier of claim 6, wherein the smooth slick surface is selected from one of plastic, glass, Teflon coated metal, polished metal, smooth painted surface and smooth varnished surface.

9. The trap barrier of claim 7, wherein the pesticide treated surface is selected from one of pyrethroids, organophosphates, repellants, and plant oils.

10. A trap barrier for insects, comprising:
a horizontal base having an upper surface and a lower surface;
a cylindrical outer wall downwardly extending below a perimeter edge of the lower surface of the base; and
a ring shaped treated surface on the lower surface of the horizontal base, the ring shaped treated surface being selected from at least one of a smooth slick surface or a pesticide treated surface on the lower surface of the horizontal base for preventing insects from traveling thereon, wherein the barrier is adapted so that furniture supported on the upper surface of the base is protected from the insects.

11. The trap barrier of claim 10, further comprising:
a peg extending upward from a mid-portion on the upper surface of the base for attachment into a furniture leg; and
a support leg extending downward from the mid portion of the lower surface of the base for elevating the outer wall, wherein the ring shaped treated surface and a floor formed of a channel formed between the downwardly extending cylindrical wall and the support leg.

12. The trap barrier of claim 10, further comprising:
a peg extending upward from a mid-portion on the base for attachment into a furniture leg; and
a caster extending downward from the mid portion of the base for elevating the downwardly extending cylindrical wall above a support surface.

13. The trap barrier of claim 10, further comprising:
a hole in the mid-portion of the upper surface of the base for allowing a fastener to attach the barrier beneath a furniture leg.

14. The trap barrier of claim 10, wherein the at least one of a smooth slick surface or pesticide treated surface is the smooth slick surface.

15. The trap barrier of claim 10, wherein the at least one of a smooth slick surface or pesticide treated surface is the pesticide treated surface.

16. The trap barrier of claim 10, wherein the at least one of the smooth slick surface or pesticide treated surface includes both the smooth slick surface and the pesticide treated surface.

17. A trap barrier for bed bugs, comprising:
a base having an upper surface and a lower surface;
a circular wall enclosure extending upward from the upper surface of the base;
a horizontal ledge extending outward from a top of the circular wall enclosure, the ledge having a lower facing surface; and
a pesticide surface treatment on the lower facing surface of the horizontal ledge, wherein the trap barrier with the pesticide surface treatment on the lower facing surface of the ledge prevents bed bugs from travelling up the trap barrier so that furniture supported inside of the wall enclosure by the base is protected from the bed bugs.

18. The trap barrier of claim 17, wherein the trap barrier further includes:
a smooth slick treatment.

19. The trap barrier of claim 17, wherein the lower facing surface includes:
a combination of a smooth slick surface treatment and the pesticide surface treatment.

20. The trap barrier of claim 17, further comprising:
a sticky surface on the trap barrier.
